(19) United States
(12) Patent Application Publication
(10) Pub. No.: US 2004/0068667 A1
(43) Pub. Date: Apr. 8, 2004

(54) Method and apparatus for securing and managing cluster computing in a network data processing system

(75) Inventors: David Bruce Kumhyr, Austin, TX (US); Michael Skibo, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 10/264,168

(22) Filed: Oct. 3, 2002

(51) Int. Cl. G06F 11/30; G06F 15/173

(52) U.S. Cl. 713/201; 709/223

(57) ABSTRACT

A method, apparatus, and computer instructions for detecting unauthorized cluster installations, managing clusters, installing clusters, and configuring clusters in a network data processing system. If a presence of cluster signatures in a number of data processing systems within the network data processing system is discovered, a determination is made as to which systems belong to respective clusters within the network data processing system. A cluster signature is used for finding a cluster. This signature may be used to identify the type and version of cluster installed. A determination is made as to whether a respective cluster is an authorized cluster. An automated action is performed in response to determining that the respective cluster is an unauthorized cluster.

### BACKGROUND OF THE INVENTION

1. Technical Field

The present invention relates generally to an improved data processing system, and in particular, to a method and apparatus for managing computing resources in a network data processing system. Still more particularly, the present invention provides a method and apparatus for securing and managing cluster computing in a network data processing system.

2. Description of Related Art

With the number of inexpensive computers and free operating system protocols that enable interconnection of computers, clustering of computers has become more common and is less expensive than many symmetric multiprocessor data processing systems and supercomputers. In this manner, many people and organizations may meet their needs for computing power with available computing systems. Clustering involves having a number of computers work together in a fashion similar to a symmetric multiprocessor system. One advantage of clustering is that these systems are simple to use and provide for near optimal resource usage. Processes or tasks may be distributed and redistributed among nodes in a cluster to improve performance. These clusters may achieve supercomputer processing on the level of million instructions per second (MIPS).

An example of clustering software is Multicomputer Operating System for Unix (MOSIX). MOSIX is a patch to a Linux kernel that enables an operating system to swap tasks among interconnected systems. This software is used to manage a group or cluster of computers to run like a symmetric multiprocessor system. This software includes adaptive management algorithms that monitor the activities of processes and available resources. MOSIX responds to uneven resource distribution and takes advantage of the best available resources within the cluster. With MOSIX, the algorithms are de-centralized with each node being both a master for processes created locally and a server for processes assigned to it from other nodes.

These interconnections with shared file systems and processes create security holes and networking loads that an organization needs to control and validate. For example, an unauthorized or unplanned creation of a cluster in a network data processing system for an organization may create hard to locate anomalies and additional security exposures within the network data processing system. A user in an information technology (IT) department may use clustering to offload processor intensive tasks to administrative computers. The users of the administrative systems may find that projects, such as the creation of books formatted with FrameMaker, may take much longer to complete since processing power within these administrative computers is reallocated by processes running for the IT department. Such a situation benefits one group in an organization while being detrimental to another group.

Therefore, it would be advantageous to have an improved method, apparatus, and computer instructions for managing clustering within a network data processing system.

### SUMMARY OF THE INVENTION

The present invention provides a method, apparatus, and computer instructions for detecting unauthorized cluster installations, managing clusters, installing clusters, and configuring clusters in a network data processing system. If a presence of cluster signatures in a number of data processing systems within the network data processing system is discovered, a determination is made as to which systems belong to respective clusters within the network data processing system. A cluster signature is used for finding a cluster. This signature may be used to identify the type and version of cluster installed. A determination is made as to whether a respective cluster is an authorized cluster. An automated action is performed in response to determining that the respective cluster is an unauthorized cluster.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram illustrating a network data processing system in accordance with a preferred embodiment of the present invention;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram illustrating a logical view of a network data processing system in accordance with a preferred embodiment of the present invention;

FIG. 5 is a diagram illustrating components used in managing cluster computing in a network data processing system in accordance with a preferred embodiment of the present invention;

FIG. 6 is a flowchart illustrating a scanning process in accordance with a preferred embodiment of the present invention; and

FIG. 7 is a flowchart illustrating a process implemented in an inventory task used to scan a node in accordance with a preferred embodiment of the present invention.

### DETAILED DESCRIPTION OF THE PREFERRED EMBODIMENT

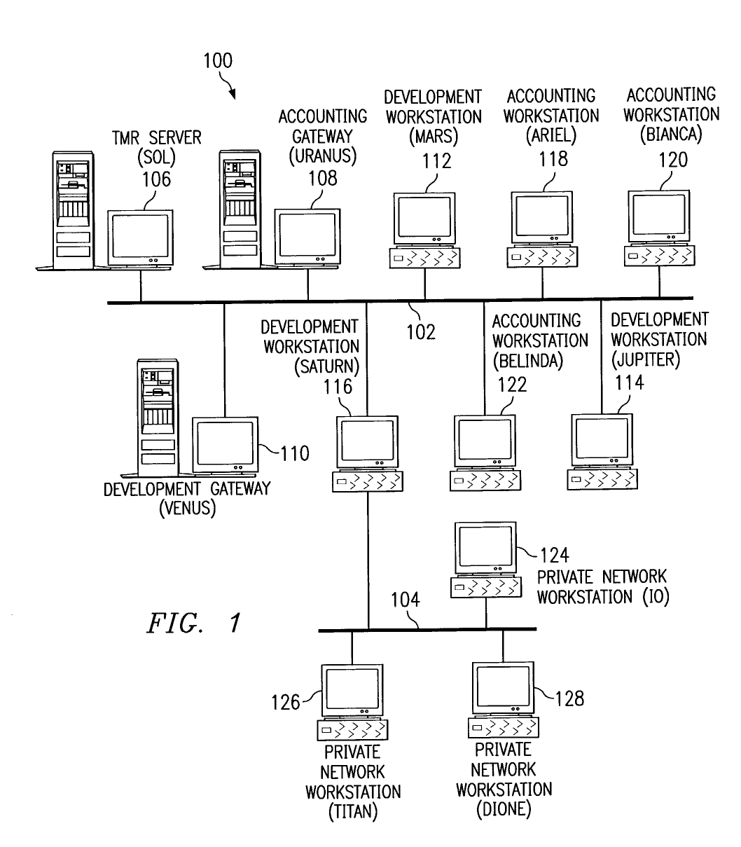

With reference now to the figures, and in particular to FIG. 1, a diagram illustrating a network data processing system is depicted in accordance with a preferred embodiment of the present invention. Network data processing system 100 is an example of a distributed computing system used by an organization. Network data processing system 100 contains network 102 and network 104, which are the medium used to provide communications links between various devices and computers connected together within network data processing system 100. Networks 102 and 104 may include connections, such as wire, wireless communication links, or fiber optic cables.

In this example, network data processing system 100 includes server 106, gateway 108, and gateway 110. These systems are connected to network 102. Development workstations 112, 114, and 116 are connected to network 102 along with accounting workstations 118, 120, and 122. Development workstation 116 is also connected to network 104. Workstations 124, 126, and 128 are also connected to network 104. Server 106 may provide files, executable programs and other resources to the different client workstations. The different workstations illustrated are clients of server 106 and may request data or store information through server 106. Gateway 108 and gateway 110 may serve as portals to access computers or networks.

Network 102 may take various forms, such as a wide area network or even the Internet. As illustrated, network 104 is a local area network. The illustration of components with network data processing system 100 is provided as an example of an environment in which the mechanism of the present invention may be implemented and is not meant as an architectural limitation as to the type of network in which the mechanism of the present invention may be implemented.

The present invention provides an improved method, apparatus, and computer instructions for managing cluster computing within a network data processing system, such as network data processing system 100. The mechanism of the present invention includes processes that are used to monitor the presence of nodes within network data processing system 100 that participate in cluster computing. The mechanism may perform various actions in response to detecting a node that is part of a cluster. These actions may range from sending a notice or message to the user of the node to removal of processes and software enabling the clustering function.

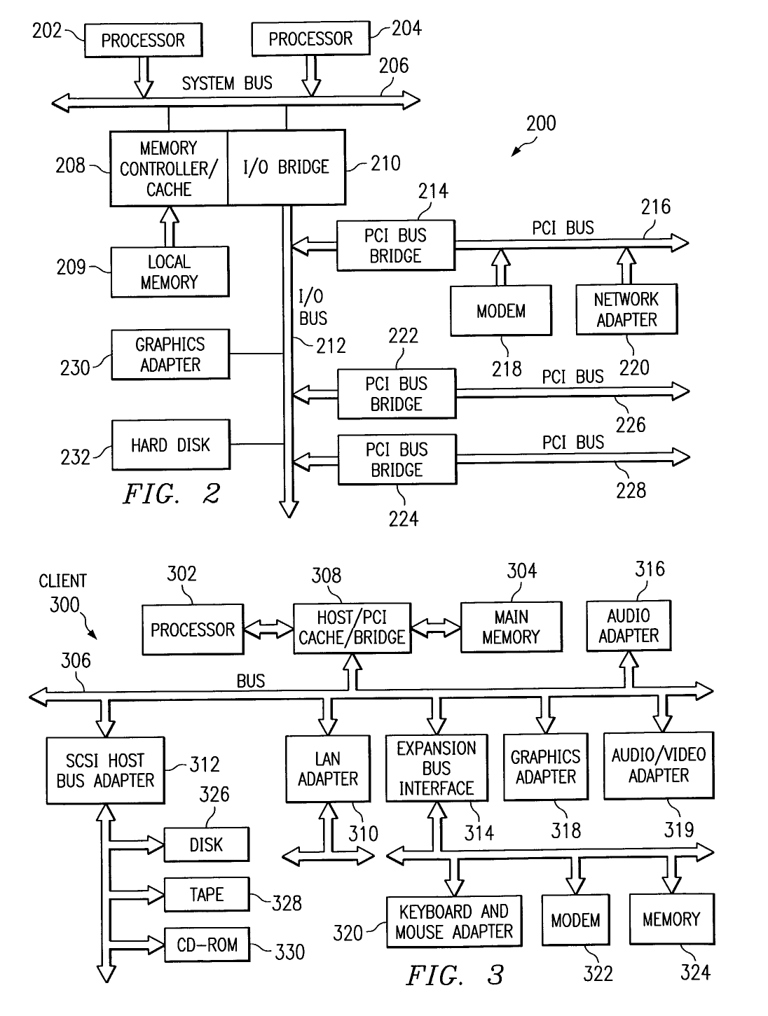

Referring to FIG. 2, a block diagram of a data processing system that may be implemented as a server, such as server 106 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to workstations in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or Linux operating system.

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330.

An operating system runs on processor 302 and is used to coordinate and provide control of various components within data processing system 300 in FIG. 3. The operating system may be a commercially available operating system, such as Windows XP, which is available from Microsoft Corporation. Instructions for the operating system and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

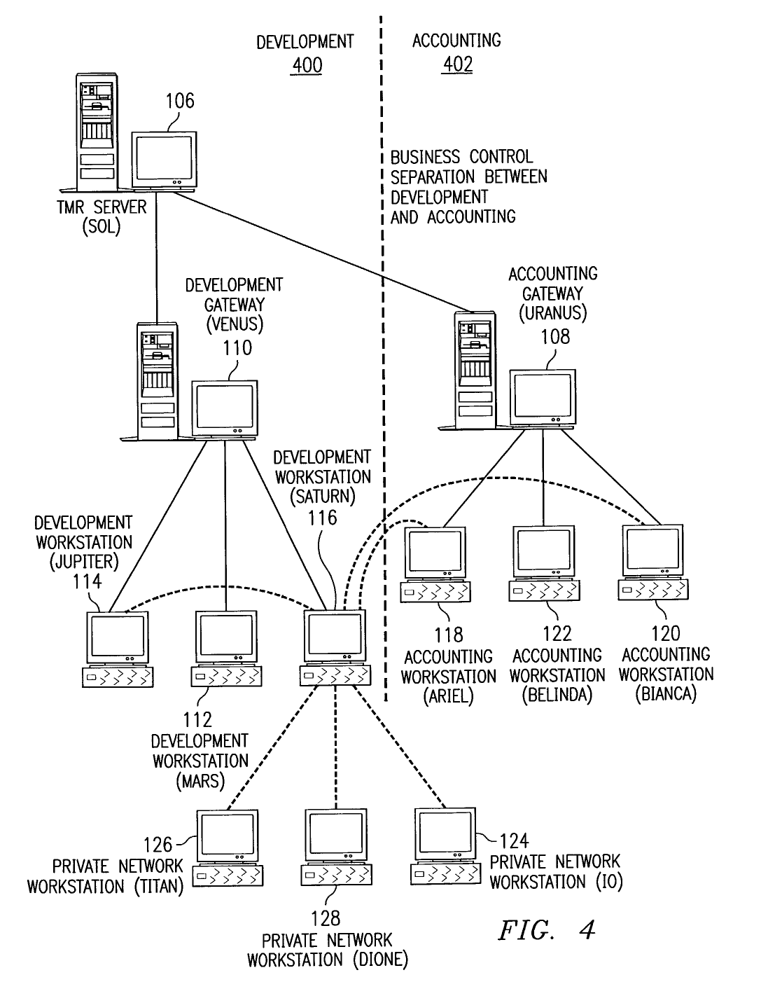

Turning now to FIG. 4, a diagram illustrating a logical view of a network data processing system is depicted in accordance with a preferred embodiment of the present invention. In this example, network data processing system 100 is illustrated in a logical view, which contains development section 400, and accounting section 402 in FIG. 4. Gateway 110 and development workstations 112-116 are part of the development section of the organization. Gateway 108 and accounting workstations 118-122 are within the accounting section of the organization. These gateways provide access to server 106.

Workstations 124-126 are part of a private network, which is set up for cluster computing. Development workstation 116 is a master node for this cluster. In this example, other computers are also part of the cluster. Development workstation 114, accounting workstation 118 and accounting workstation 120 are also part of this cluster. In this example, workstations 124-128, development workstation 114, and development workstation 116 are authorized nodes, while accounting workstation 118 and accounting workstation 120 are unauthorized nodes within the cluster. Accounting workstation 118 and accounting workstation 120 are unauthorized nodes in the cluster in this example because the clustering extends across two different business sections. Of course, in other cases, such clustering may be authorized depending on the policy set up by the organization with respect to clustering.

The mechanism of the present invention provides for identifying unauthorized clusters or unauthorized nodes within a cluster. The present invention recognizes that each of the clustering applications or protocols have signatures that identify them. These signatures may include, for example, specific file types, configuration files, and particular network traffic patterns. Network traffic patterns may indicate the presence of nodes that are part of a cluster. For example, TCP/IP traffic between nodes on certain ports or packets containing certain types of data, such as control messages, may be used as a signature to identify the presence of nodes in a cluster.

If clustering is detected based on the presence of one or more signatures, corrective actions may be automatically initiated depending on whether the cluster is authorized. If clustering is authorized within the network data processing system, each individual node within the cluster is identified. When a node that is part of a cluster is identified, a determination may be made as to whether the node is authorized for use in the cluster. If the node is unauthorized, a corrective action may be automatically initiated.

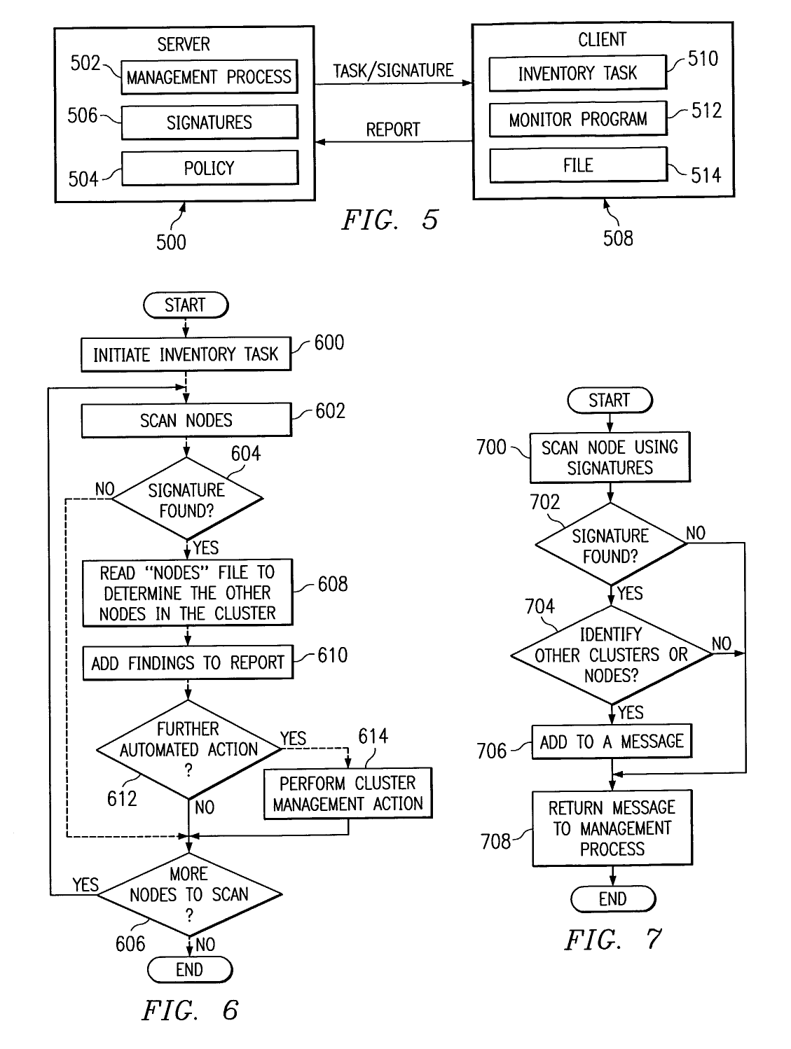

With reference now to FIG. 5, a diagram illustrating components used in managing cluster computing in a network data processing system is depicted in accordance with a preferred embodiment of the present invention. Server 500 contains management process 502, policy 504, and signatures 506. Server 500 may be implemented in one or more computers in a network data processing system, such as network data processing system 100 in FIG. 1. For example, server 500 may be located within a data processing system, such as server 106, gateway 110, or development workstation 112, depending on the particular implementation.

Management process 502 provides for the scanning of nodes within the network data processing system as well as initiating various actions in response to the detection of a cluster within the network data processing system. Nodes participating in clustering may be identified through the use of signatures 506, which contains information used in detecting whether a node contains cluster processes, such as MOSIX or Beowulf. Clustering applications contain specific signatures that may be detected through scanning of the network data processing system. For example, with MOSIX, the presence of a file, mosix.map, is an example of a signature. This file contains a list of all clusters and may be used to find other nodes. An entry specifying a MOSIX system port as “MFS port 723” is another piece of data that is a signature. A path “/proc/MOSIX” or the presence of a MOSIX monitor program “mon” are other examples of signatures. For a Beowulf cluster, a presence of a “LAM” network daemon for testing and debugging for interconnection between Beowulf nodes is an example of a signature. A “lamhosts” file is another signature indicating Beowulf clustering. This file contains a list of all nodes within the cluster. Other signatures include a presence of “mpitask's” in the process stack or a presence of a path “/etc/beowulf”. The scanning for these signatures may be implemented using various scanning processes well known in anti-virus programs.

Scanning may occur directly or through server 500 sending a task and a signature to client 508. In this example, inventory task 510 is sent to client 508 and performs scanning of client 508. The scanning may be initiated by management process 502 in response to an event. This event may be periodic or non-periodic. For example, the scanning may be initiated through the expiration of a timer or at the beginning of each week. A non-periodic event that may initiate scanning may be, for example, the addition of a new workstation or a new user to the network data processing system.

The signature or set of signatures that are to be scanned for may be sent from signatures 506 to client 508 with inventory task 510. In this example, signatures 506 may be used by inventory task 510 to identify monitor program 512 and file 514 as matching a signature indicating the presence of a cluster process within client 508. Further, if file 514 is a file, such as a lamhosts file, this file may be used to identify additional nodes within the cluster. This information is sent back in a report or message to server 500.

The information may be used to determine whether action is to be initiated using policy 504. This policy identifies various rules established by the organization or administrator. For example, policy 504 may specify that no clustering is allowed. In this case, management process 502 may automatically initiate a corrective action to remove monitor program 512 and file 514 from client 508. The same action may be taken with respect to other nodes identified from file 514.

Alternatively, policy 504 may allow for clustering only through a company specified format. Clustering may be allowed through the use of only selected types of clustering applications. For example, Beowulf clustering may be allowed while MOSIX clustering is prohibited. In such a situation, if a prohibited clustering application is present, a corrective action may be automatically initiated in which the prohibited clustering application is replaced with the authorized one. Policy 504 also may specify clustering following rules as to the selection of host nodes. For example, clustering may not extend across business control boundaries, such as, for example, development section 400 and accounting section 402 in FIG. 4. Clustering also may be allowed only within certain organizational areas. Many other rules may be implemented or used in addition to or in place of these examples depending on the particular implementation of the present invention.

With reference now to FIG. 6, a flowchart illustrating a scanning process is depicted in accordance with a preferred embodiment of the present invention. The process illustrated in FIG. 6 may be implemented using a software component, such as management process 502 in FIG. 5.

The process begins by initiating an inventory task (step 600). This task is a process used to scan a node and may be located in management process 502 or may be sent to a client in the form of inventory task 510. As part of the initiation of the inventory task, signatures are selected or inputted into the inventory task. A node is then selected for scanning (step 602). A determination is made as to whether a signature is found within the selected node (step 604). If a node is not found, a determination is made as to whether additional nodes are present for scanning that have not been scanned (step 606). If additional nodes are absent, the process terminates. Otherwise, the process returns to step 602.

With reference again to step 604, if a signature is found, a node file within the node is identified to determine other nodes that may be present in the cluster (step 608). Any identified nodes are added to a report (step 610). A determination is then made as to whether any further automated actions are to be taken (step 612). If no further actions are to be taken, the process returns to step 606 as described above. If an additional automated action is to be taken, a cluster management action is initiated based on a policy (step 614). The actions taken may include, for example, deleting installation of the cluster software on the node, sending a warning to the user of the node, and deleting installation of the clustering software and installing an approved cluster software application. For example, the clustering software may be of the right type but not approved because the version of the clustering software is outdated. The versioning information may be identified from the signature detected. If the version is incorrect, a correct version may be installed. Other actions that may be taken may include determining whether business or other controls are violated by the presence of the clustering software on this node or verifying whether the installation meets guidelines set up for the organization.

With reference now to FIG. 7, a flowchart illustrating a process implemented in an inventory task used to scan a node is depicted in accordance with a preferred embodiment of the present invention. The process illustrated in FIG. 7 may be implemented using a software component, such as inventory task 510 in FIG. 5.

The process begins by scanning the node using signatures (step 700). These signatures are ones that indicate a presence of a clustering process on a node. A determination is made as to whether one or more signatures are found on the node (step 702). If a signature is found on the node, a determination is made as to whether other nodes or clusters can be identified (step 704). Other nodes or clusters may be identified through the presence of files used by the clustering process. For example, a mosix.map file may be used to identify other clusters while a lamhosts file may be used to identify nodes within the cluster. If other nodes are identified, the identification of these nodes is added to a message (step 706). The message is then returned to the management process (step 708) with the process terminating thereafter.

Turning back to step 704, if no other clusters or nodes are identified, the message returned in step 708 merely indicates that the node is part of a cluster. With reference again to step 702, if a signature is not found, the message returned in step 708 indicates that no clustering processes have been found on the node.

Thus, the present invention provides an improved method, apparatus, and computer instructions for managing clustering within a network data processing system. The presence of a cluster is detected through the use of signatures. When a cluster is detected, various actions may be taken to implement the policies or rules set up for the particular network data processing system. In this manner, inefficiencies or security breaches introduced by unauthorized clusters may be eliminated. Increased performance may be achieved when clustering is authorized by the use of appropriate clustering software or by allowing clusters that control nodes based on business or organizational schemes.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. In the illustrated embodiment, the mechanism of the present invention is illustrated as being used to detect cluster systems. The mechanism of the present invention also may be used to manage, distribute, install, and configure clusters in a network data processing system. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for detecting unauthorized cluster installations in a network data processing system, the method comprising:
discovering a presence of cluster signatures in a number of data processing systems within the network data processing system;
determining which systems belong to respective clusters within the network data processing system;
determining whether a respective cluster is an authorized cluster or-an unauthorized cluster; and
performing a automated action in response to determining that the respective cluster is an unauthorized cluster.

2. The method of claim 1, wherein the automated action includes at least one of deleting an installation of the unauthorized cluster, sending a warning to a user of the unauthorized cluster, sending a notification to an administrator, and replacing the unauthorized cluster by installing an approved installation after deleting installation of the unauthorized cluster.

3. The method of claim 1, wherein the automated action includes at least one of determining whether business controls have been violated, determining whether security controls have been violated, and determining whether installation of the unauthorized cluster meets a policy.

4. The method of claim 1, wherein the cluster signatures are one of a file, a monitoring program, a directory, a port designation, or a selected task on a process stack.

5. A method for managing clusters in a network data processing system, the method comprising:
searching the network data processing system for a cluster signature, wherein the cluster signature indicates an installation of a clustering software;
responsive to finding a cluster signature on a data processing system within the network data processing system, determining whether the installation of the clustering software is authorized or unauthorized; and
responsive to determining that the installation is unauthorized, performing an automated action.

6. The method of claim 5, wherein the automated action includes at least one of deleting an installation of the unauthorized cluster, sending a warning to a user of the unauthorized cluster, sending a notification to an administrator upgrading a version of the clustering software to an approved version, and replacing the unauthorized cluster by installing an approved installation after deleting installation of the unauthorized cluster.

7. The method of claim 5, wherein the automated action includes at least one of determining whether business controls have been violated, determining whether security controls have been violated, and determining whether installation of the unauthorized cluster meets a policy.

8. The method of claim 5, wherein the cluster signature is one of a file, a monitoring program, a directory, a port designation, or a selected task on a process stack.

9. A method for installing a cluster in a network data processing system, the method comprising:
scanning the network data processing system for cluster signatures;
responsive to a presence of an authorized cluster signature on a node in the network data processing system, determining a version of clustering software on the node to form an identified version;
determining whether the identified version is a correct version of the clustering software or an incorrect version of the clustering software; and
installing a correct version of the clustering software if the identified version is an incorrect version of the clustering software.

10. The method of claim 9 further comprising:
installing the correct version of the clustering software on selected nodes in the network data processing system if an absence of cluster signatures is detected when scanning the network data processing system.

11. A data processing system for detecting unauthorized cluster installations in a network data processing system, the data processing system comprising:
a bus system;
a communications unit connected to the bus system;
a memory connected to the bus system, wherein the memory includes a set of instructions; and
a processing unit connected to the bus system, wherein the processing unit executes the set of instructions to discover a presence of cluster signatures in a number of data processing systems within the network data processing system; determine which systems belong to respective clusters within the network data processing system; determine whether a respective cluster is an authorized cluster or an unauthorized cluster; and perform a automated action in response to determining that the respective cluster is an unauthorized cluster.

12. A data processing system for managing clusters in a network data processing system, the data processing system comprising:
a bus system;
a communications unit connected to the bus system;
a memory connected to the bus system, wherein the memory includes a set of instructions; and
a processing unit connected to the bus system, wherein the processing unit executes the set of instructions to search the network data processing system for a cluster signature in which the cluster signature indicates an installation of a clustering software; determine whether the installation of the clustering software is authorized or unauthorized in response to finding a cluster signature on a data processing system within the network data processing system; and perform an automated action in response to determining that the installation is unauthorized.

13. A data processing system for installing a cluster in a network data processing system, the data processing system comprising:
a bus system;
a communications unit connected to the bus system;
a memory connected to the bus system, wherein the memory includes a set of instructions; and
a processing unit connected to the bus system, wherein the processing unit executes the set of instructions to scan the network data processing system for cluster signatures; determine a version of clustering software on the node to form an identified version in response to a presence of an authorized cluster signature on a node in the network data processing system; determine whether the identified version is a correct version of the clustering software or an incorrect version of the clustering software; and install a correct version of the clustering software if the identified version is an incorrect version of the clustering software.

14. A data processing system for detecting unauthorized cluster installations in a network data processing system, the data processing system comprising:
discovering means for discovering a presence of cluster signatures in a number of data processing systems within the network data processing system;
first determining means for determining which systems belong to respective clusters within the network data processing system;
second determining means for determining whether a respective cluster is an authorized cluster or an unauthorized cluster; and
performing means for performing a automated action in response to determining that the respective cluster is an unauthorized cluster.

15. The data processing system of claim 14, wherein the automated action includes at least one of deleting an installation of the unauthorized cluster, sending a warning to a user of the unauthorized cluster, sending a notification to an administrator, and replacing the unauthorized cluster by installing an approved installation after deleting installation of the unauthorized cluster.

16. The data processing system of claim 14, wherein the automated action includes at least one of determining whether business controls have been violated, determining whether security controls have been violated, and determining whether installation of the unauthorized cluster meets a policy.

17. The data processing system of claim 14, wherein the cluster signatures are one of a file, a monitoring program, a directory, a port designation, or a selected task on a process stack.

18. A data processing system for managing clusters in a network data processing system, the data processing system comprising:
searching means for searching the network data processing system for a cluster signature, wherein the cluster signature indicates an installation of a clustering software;
determining means, responsive to finding a cluster signature on a data processing system within the network data processing system, for determining whether the installation of the clustering software is authorized or unauthorized; and
performing means, responsive to determining that the installation is unauthorized, for performing an automated action.

19. The data processing system of claim 18, wherein the automated action includes at least one of deleting an installation of the unauthorized cluster, sending a warning to a user of the unauthorized cluster, sending a notification to an administrator upgrading a version of the clustering software to an approved version, and replacing the unauthorized cluster by installing an approved installation after deleting installation of the unauthorized cluster.

20. The data processing system of claim 18, wherein the automated action includes at least one of determining whether business controls have been violated, determining whether security controls have been violated, and determining whether installation of the unauthorized cluster meets a policy.

21. The data processing system of claim 18, wherein the cluster signature is one of a file, a monitoring program, a directory, a port designation, or a selected task on a process stack.

22. A data processing system for installing a cluster in a network data processing system, the data processing system comprising:
scanning means for scanning the network data processing system for cluster signatures;
first determining means, responsive to a presence of an authorized cluster signature on a node in the network data processing system, for determining a version of clustering software on the node to form an identified version;
second determining means for determining whether the identified version is a correct version of the clustering software or an incorrect version of the clustering software; and
installing means for installing a correct version of the clustering software if the identified version is an incorrect version of the clustering software.

23. The data processing system of claim 22, wherein the installing means is a first installing means and further comprising:
second installing means for installing the correct version of the clustering software on selected nodes in the network data processing system if an absence of cluster signatures is detected when scanning the network data processing system.

24. A computer program product in a computer readable medium for detecting unauthorized cluster installations in a network data processing system, the computer program product comprising:
first instructions for discovering a presence of cluster signatures in a number of data processing systems within the network data processing system;
second instructions for determining which systems belong to respective clusters within the network data processing system;
third instructions for determining whether a respective cluster is an authorized cluster or an unauthorized cluster; and
fourth instructions for performing a automated action in response to determining that the respective cluster is an unauthorized cluster.

25. A computer program product in a computer readable medium for managing clusters in a network data processing system, the computer program product comprising:
first instructions for searching the network data processing system for a cluster signature, wherein the cluster signature indicates an installation of a clustering software;
second instructions, responsive to finding a cluster signature on a data processing system within the network data processing system, for determining whether the installation of the clustering software is authorized or unauthorized; and
third instructions, responsive to determining that the installation is unauthorized, for performing an automated action.

26. A computer program product in a computer readable medium for installing a cluster in a network data processing system, the computer program product comprising:
first instructions for scanning the network data processing system for cluster signatures;
second instructions, responsive to a presence of an authorized cluster signature on a node in the network data processing system, for determining a version of clustering software on the node to form an identified version;
third instructions for determining whether the identified version is a correct version of the clustering software or an incorrect version of the clustering software; and
fourth instructions for installing a correct version of the clustering software if the identified version is an incorrect version of the clustering software.
